(19) United States
(12) Patent Application Publication
(10) Pub. No.: US 2014/0093707 A1
(43) Pub. Date: Apr. 3, 2014

(54) Method of Producing a Motif Having Reflecting Properties and Transferring said Motif onto a Substrate, and a Reflection Transfer Film

(71) Applicant: Harald Kaufmann, Hattingen (DE)

(72) Inventor: Harald Kaufmann, Hattingen (DE)

(21) Appl. No.: 14/115,653

(22) PCT Filed: May 4, 2012
(86) PCT No.: PCT/EP2012/058213

§ 371 Date: Nov. 7, 2013

Related U.S. Application Data
(60) Provisional application No. 61/484,714, filed on May 11, 2011.

(30) Foreign Application Priority Data
May 11, 2011 (DE) 10 2011 075 647.7

(51) Int. Cl. B44C 1/10; D06Q 1/10

(52) U.S. Cl. CPC B44C 1/105; D06Q 1/10
USPC 428/195.1; 156/230

(57) ABSTRACT

A method of producing a motif having reflecting properties and transferring said motif onto a substrate includes providing an adhesive-repellent base medium; applying a transfer adhesive to the base medium over the full surface area; applying a reflection colorant which contains a multiplicity of reflection particles; cutting a motif into the layer structure produced, wherein a projecting region remains; removing said projecting region; and applying the layer structure having the motif, after removal of the base medium, to a substrate.

### BACKGROUND OF THE INVENTION

1. Field of the invention

The invention concerns a method of producing a motif having reflecting properties and transferring said motif onto a substrate, wherein the motif is produced by cutting into a reflection transfer film and is transferred by a transfer process. The invention further concerns a reflection transfer film and a textile product.

2. State of the art

DE 1 446 828 A1 discloses a reflecting transfer film and a process for the production of reflex-reflecting articles, for example for marking articles of clothing. The transfer film has a transfer layer comprising an adhesive layer, a rubber-like bonding agent layer disposed thereon, with incorporated, partly protruding microballs, and a strippable protective layer on the adhesive side of the transfer layer. On its front side the transfer layer has a dimensionally stable carrier substrate which can be stripped off dry after being glued on. For transfer onto an article of clothing a hot iron is firmly pressed onto the carrier substrate of the structure and then the carrier substrate is stripped off the reflex-reflecting transfer film. To apply markings of different kinds of shapes the respective motifs are firstly cut out and then applied to the subjacent article of clothing or fabric.

US 2007/0162176 A1 discloses inter alia methods of and apparatuses for applying appliques for example to articles of clothing, in which, to combine two or more symbols or images in a design, a first pattern is cut out of a first material to form a lower layer, then a second pattern is cut out of a second material to form an upper layer, and then the two layers are applied to the article of clothing.

U.S. Pat. No. 5,974,997 discloses inter alia a decoration article in which a decorative material is fixed on a base material by means of a trim material and wherein the trim material is fixed to the decorative material by means of a first fixing material and to the base material by means of a second fixing material.

### SUMMARY OF THE INVENTION

The object of the present invention is to provide a method of producing a motif having reflecting properties and transferring said motif onto a substrate, which furnishes a (for example textile) product having attractive reflection properties and at the same time permits the economic production of patterns or small-scale series.

That object is attained by the method having the features of independent claim 1.

A method according to the invention of producing a motif having reflecting properties and transferring said motif onto a substrate, comprises the following steps:
providing an adhesive-repellent base medium;
applying a transfer adhesive to the base medium over the full surface area;
applying a reflection colorant which contains a multiplicity of reflection particles;
cutting a motif into the layer structure produced, wherein a projecting region remains;
removing said projecting region; and
applying the layer structure having the motif, after removal of the base medium, to a substrate.

The invention is based in particular on the concept that the motif which ultimately is wanted is not already formed during production of the layer structure, but the transfer adhesive is firstly applied over the full surface area (and possibly or according to the respective embodiment involved, also the reflection colorant having the reflection particles).

Selection and production of the motif that is ultimately wanted is only effected after the reflection transfer film has been completely produced, and accordingly in particular that can also first be implemented for example on the part of a customer who can predetermine the desired motif which is to be cut into the completely produced layer structure (for example by means of a cutting computer or also by means of a laser, a cutting machine, shears or a punch). In that respect there is no longer any need for the specific design wishes of the customer to be already implemented during production of the reflection transfer film having the reflecting properties, or for the reflection transfer film to be already provided with suitable motifs in accordance with the customer wish.

As a result the invention provides a method which is particularly economical for the production of small-scale series as well as individual pieces and patterns.

At the same time, the procedure according to the invention, in production of the reflection transfer film, provides that the reflection properties are substantially improved by virtue of the fact that firstly the procedure begins with the adhesive-repellent base medium, that is then provided with a transfer adhesive and only then with reflection colorant, in comparison with a conventional method in which firstly the colorant and then the adhesive are applied to a transfer carrier and a motif is firstly applied by printing to the transfer carrier in mirror-reversed relationship, as, in contrast to the rather unified appearance which is achieved with the conventional approach, the reflection particles are raised above the dried colorant layer. The material produced in that way is particularly excellently well suited to being refined and improved with further printing inks/effects so that highly effective and personalized films can be produced. In that respect it is possible to make use of the fact that, with the reflection transfer film used according to the invention, the surface with the reflection particles is open upwardly and is not covered over by a transfer tape.

In an embodiment the reflection colorant is applied over the full surface area.

In a further embodiment application of the reflection colorant can also be only partially effected. That partial application of the reflection colorant provides that for example an additional structure (for example in the form of a mark identification which can be perceived as a continuous pattern) can be produced within the actual motif subsequently produced by cutting into the layer structure. As in that case, upon irradiation (for example at night or at twilight), only the structure in question, which is applied by means of reflection colorant, reflects, further attractive effects can be produced. It is also possible in that way to prevent a reflection action which under some circumstances is otherwise excessively strong, or “excessive irradiation”, for example on white substrates (with the result that the actual motif cannot be seen or can no longer be exactly seen).

Application of the layer structure having the motif to the substrate can be effected using a transfer tape. The invention however is not restricted thereto. Rather, transfer of the layer structure onto the textile substrate can also be effected directly, dispensing with a transfer tape.

In an embodiment cutting of the motif into the reflection transfer film or the layer structure produced is effected in correct left-to-right relationship. In that case in particular a transfer tape can be applied to the layer structure having the motif, after removal of the projecting region.

In an alternative embodiment the transfer tape is applied (preferably over the full surface area) prior to the motif being cut into the reflection transfer film or the layer structure produced. In that case in particular the operation of cutting the motif is effected, after removal of the base medium, in mirror-image relationship. That has the advantage precisely in the case of comparatively small motifs that weeding and also repair or re-positioning of motif elements which are defective or removed by error is simplified.

In an embodiment the steps of providing the adhesive-repellent base medium, applying the transfer adhesive to the base medium over the full surface area and applying a reflection colorant are respectively performed in a roll coating process or a roll printing process. In that way it is possible to achieve a substantial increase in respect of the amounts produced and the production speed, in comparison with the use of sheet laminating, sheet cutting and sheet draw-off machines

In an embodiment at least one intermediate layer is applied to the transfer adhesive after application of the transfer adhesive over the full surface area and prior to application of the actual reflection colorant. That intermediate layer includes one or also a plurality of additional layer portions. In addition the at least one intermediate layer can be colored, transparent or non-transparent.

That layer portions in the intermediate layer can be in turn either color layers comprising one or more, preferably high-coverage color or colors which are not reflection colorants, or also any other layer portions. The intermediate layer, like also the transfer adhesive, can also be of such a nature (in particular in respect of its strength and elasticity properties) that it promotes or does not impede the cutting operation according to the invention and the subsequent weeding operation. The intermediate layer can be applied over the full surface area involved (without the invention being restricted thereto). In addition the intermediate layer in turn can again be provided with one or more motifs. The intermediate layer can be produced by means of digital printing, graphic screen printing or other current coating procedures and can also be applied by printing or coating, by means of a suitable process. The thickness of the intermediate layer is so selected that that it supports the cutting operation and just by way of example can be in the range of between 10 μm and 50 μm.

In an embodiment application of the transfer adhesive over the full surface area is effected in an extrusion process or a coating process.

In an embodiment after application of the reflection colorant (partially or over the full surface area) to reflecting regions formed by the reflection colorant, non-reflecting elements, in particular for example flock stripes (designs) or non-reflecting colors, can be applied (for example by printing). In that way “refining” of the reflection transfer, which permits further additional design effects and in particular also a differing day/night action, can also be achieved prior to production of the actual motif or prior to delivery of the reflection transfer film to the customers.

The invention further concerns a textile product produced by a method according to the invention, in which case a textile substrate is adopted as the substrate.

In a further aspect the invention concerns a reflection transfer film which is produced by the following steps:
providing an adhesive-repellent base medium;
applying a transfer adhesive to the base medium over the full surface area;
applying a reflection colorant which contains a multiplicity of reflection particles;
cutting a motif in correct left-to-right relationship into the layer structure produced in the preceding steps, wherein a projecting region remains; and
removing said projecting region.

In regard to preferred configurations and advantages of the reflection transfer film reference is made to the foregoing description in connection with the method.

Further configurations of the invention are to be found in the description and the appendant claims.

The invention is described in greater detail hereinafter by means of embodiments by way of example illustrated in the accompany drawings.

### BRIEF DESCRIPTION OF THE DRAWINGS

In the drawings:

FIG. 1 shows a flow chart to illustrate a method according to the invention in a preferred embodiment,

FIG. 2 shows diagrammatic views to illustrate the method according to the invention of FIG. 1,

FIG. 3 shows a flow chart to illustrate a method according to the invention in a further embodiment,

FIG. 4 shows diagrammatic views to illustrate the method according to the invention of FIG. 3,

FIGS. 5a-5b show diagrammatic views to illustrate a further possible modification of the method according to the invention of FIG. 1,

FIG. 6 shows a flow chart to illustrate a method according to the invention in a further embodiment,

FIGS. 7a-7b show diagrammatic views to illustrate the method according to the invention of FIG. 6, and

FIG. 8 shows a diagrammatic view to illustrate the structure of a reflection transfer film used in the method according to the invention.

### DETAILED DESCRIPTION OF PREFERRED EMBODIMENTS

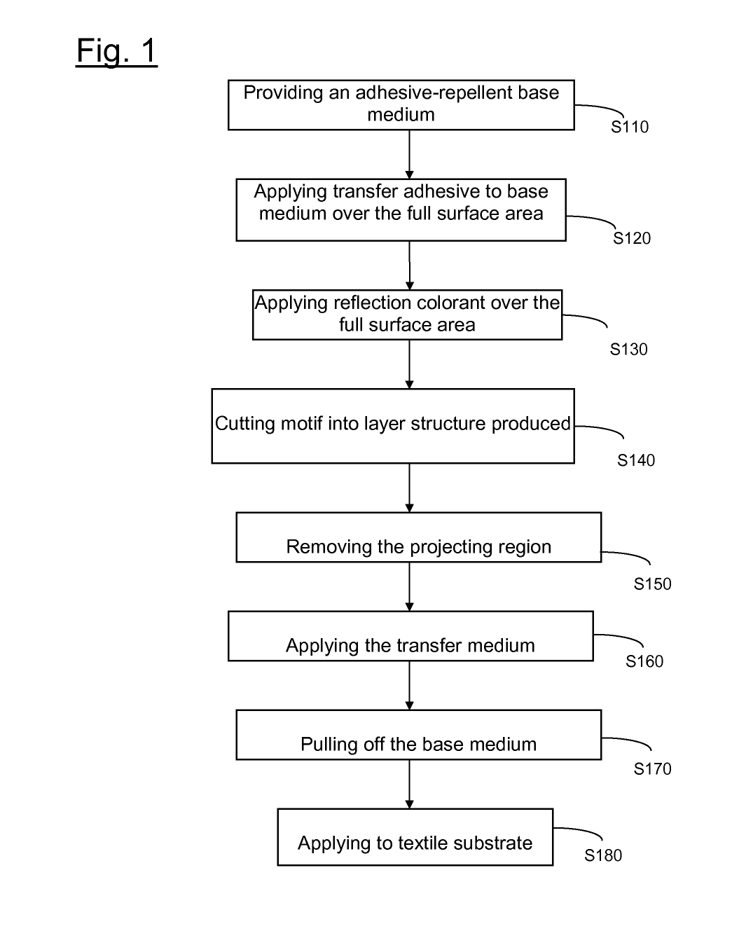

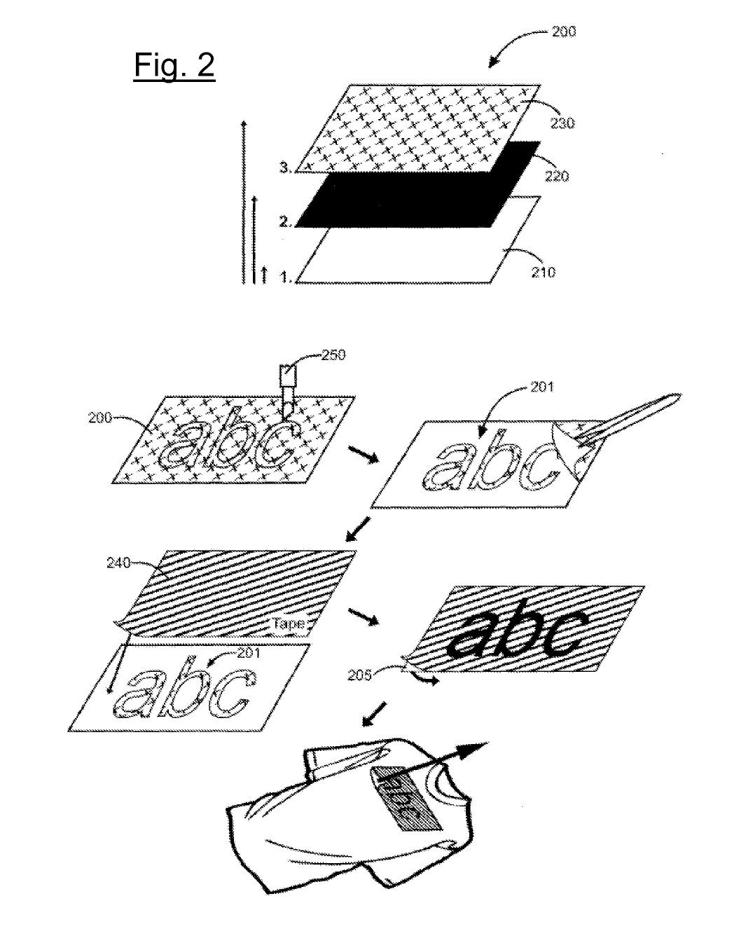

Hereinafter a preferred embodiment of the method according to the invention is described with reference to the flow chart shown in FIG. 1 and the diagrammatic views in FIG. 2 serving for illustration purposes. In the first embodiment in a step S110 an adhesive-repellent base medium 205 is provided, which for example can be an adhesive-repellent protective paper, for example on a silicone basis (siliconized paper) or on a polyester basis (adhesive-repellent polyester material). The “adhesive-repellent” property of the base medium is in that respect preferably to be interpreted as meaning that the adhesive firstly binds well to the base material of the base medium and can be deposited thereon in bubble-free and homogenous relationship, in which respect the adhesive can then be later detached from that base material without any problem and in destruction-free fashion.

A transfer adhesive 210 is applied to that base medium 205 over the full surface area involved (step S120). The transfer adhesive 210 used can be applied to the base medium 205 by means of any suitable method, for example an extrusion method, a screen printing method (as described in EP 1 137 546 B1), a suitable coating method or in any other fashion, and preferably dried. A suitable transfer adhesive 210 is for example a thermoplastic co-polyester hot melt adhesive film. Aqueous adhesives, plastisol adhesives, solvent adhesives, polyurethane adhesives etc. are also suitable.

Now, in step S130, a reflection colorant which contains a multiplicity of reflection particles (for example of a maximum size of 45 μm) is also applied over the full surface area involved to that (optionally dried) transfer adhesive 210. It is then optionally dried. The diagrammatic view in FIG. 2 shows the layer structure produced, without the base medium 205, but in return with an optional intermediate layer 220 between the transfer adhesive 210 and the reflection colorant 230.

A motif 201 is now cut in step S140 through the layer structure produced in the preceding steps, this being effected for example using a cutting computer. Cutting of the motif can be effected in accordance with the invention in any suitable fashion, for example also by stamping or by means of a laser.

After removal of the projecting material (by means of “weeding”) in step S150, step S160 is effected, involving the application of a transfer tape (identified by reference 240 in FIG. 2), for which purpose it is possible to use for example a laminating machine in the form of a roller or a flat bed laminator. The transfer tape 240 can also be applied manually. Removal of the base medium 205 is then effected in step S170, exposing the transfer adhesive 210 with which now the layer structure is applied to a textile substrate (in step S180 and as shown in FIG. 2) and pressed thereto for example by means of a transfer press by means of heat and/or pressure. A smoothing iron can also be used for that purpose in a domestic situation. Finally the transfer tape 240 is pulled off so that the exposed motif 201 remains on the textile substrate.

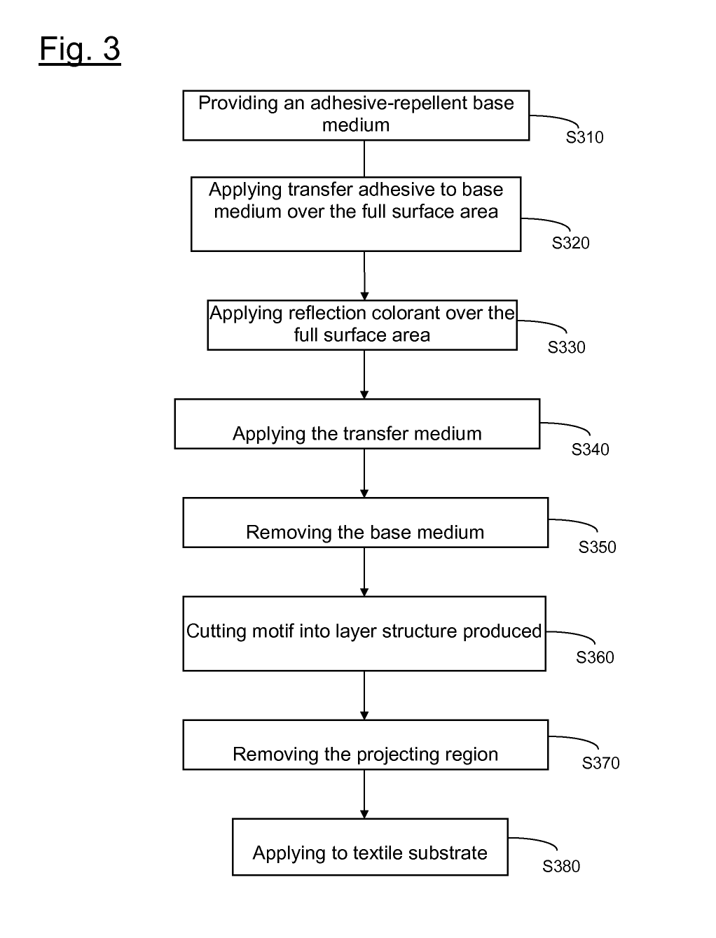

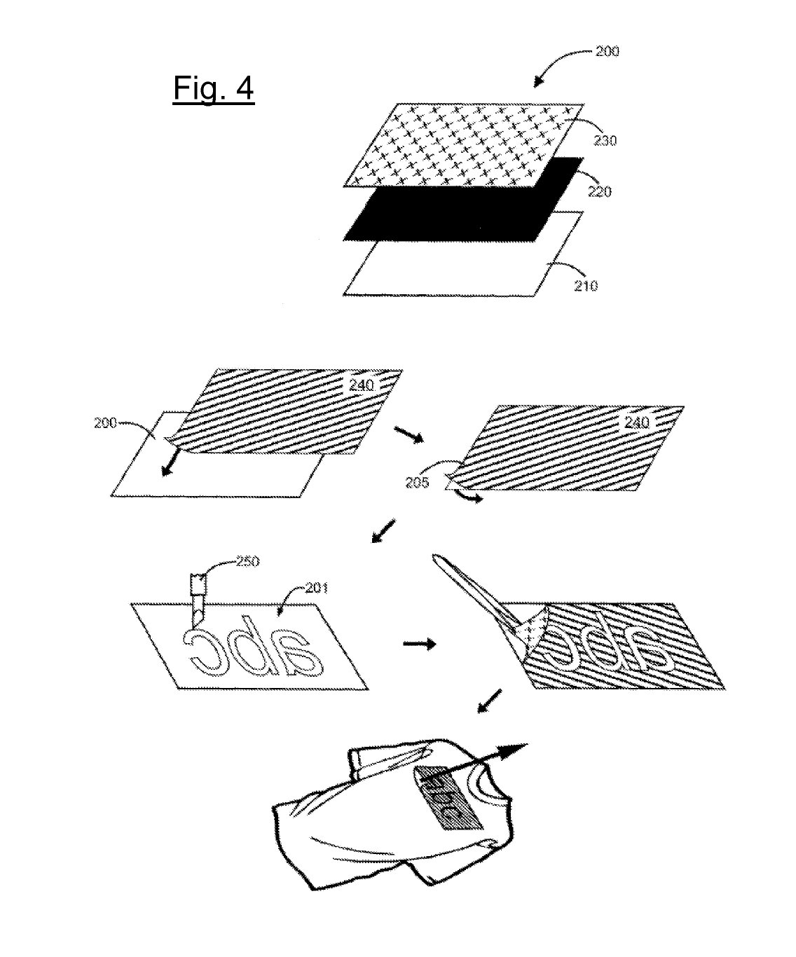

In the embodiment described hereinbefore with reference to FIGS. 1 and 2, the operation of cutting the motif 201 is effected in step S140 in correct left-to-right relationship, as can also be seen from FIG. 2. The invention however is not restricted thereto. Rather, cutting of the motif 201 can also be effected in mirror-image relationship as described by means of a further embodiment with reference to FIGS. 3 and 4.

The corresponding method which is described by means of the flow chart in FIG. 3 firstly differs from that shown in FIG. 1 in that the transfer tape 240 is applied (step S340) to the layer structure produced in the first three steps S310-S330 (identical to FIG. 1), prior to cutting of the motif (application preferably being over the full surface area involved). Thereupon firstly the base medium 205 is removed in step S350 and it is only then that the motif 201 is cut—now in side-reversed relationship or mirror-image relationship—. Then once again the projecting region is removed (by “weeding”, step S370), and application to a textile substrate is effected in step S380, whereupon finally the transfer tape 240 is removed so that the exposed motif 201 remains on the textile substrate.

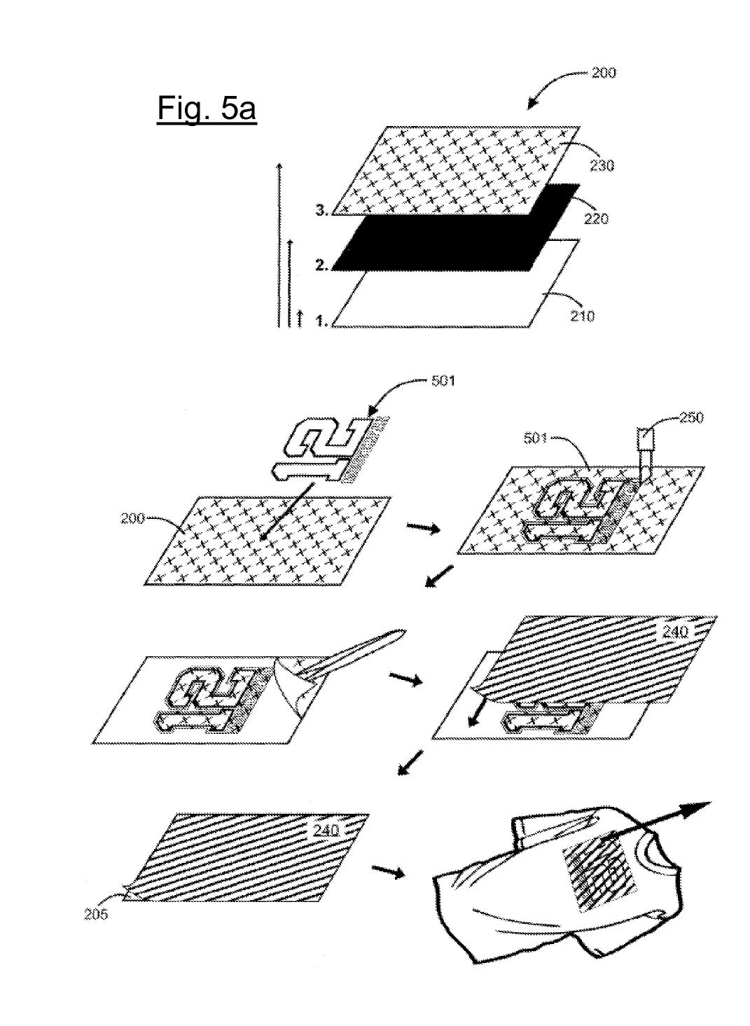

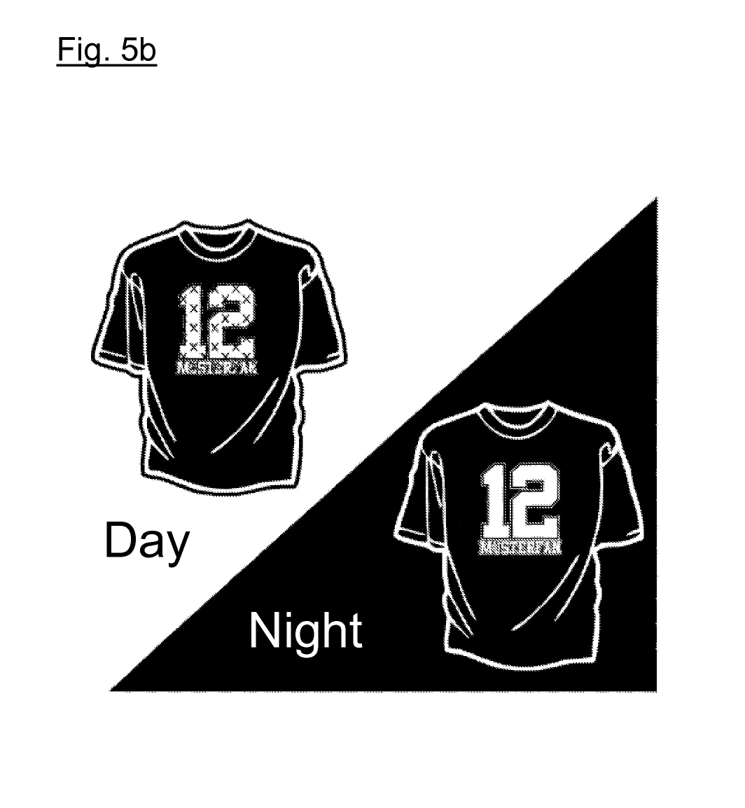

In further embodiments, as shown in FIG. 5 and in a modification of the method described hereinbefore with reference to FIG. 1, non-reflecting elements 501 such as for example flock stripes (designs), non-reflecting or less-reflecting colors etc. can be applied by printing to the reflecting regions. For example, design elements with a lower degree of reflection (for example 10%) can be applied to a strongly reflecting color (for example almost 100% reflecting). In addition, it is additionally possible to travel by means of the laser unit over the reflection transfer or the film in order to hatch for example the surface thereof, to “destroy” the reflection at the surface in region-wise fashion in specifically targeted relationship and to achieve attractive effects (“reflection/non-reflection”). In addition it is also possible to make use of the fact that, with the reflection transfer used in accordance with the invention, the surface with the reflection particles is open upwardly and is not covered with a transfer tape.

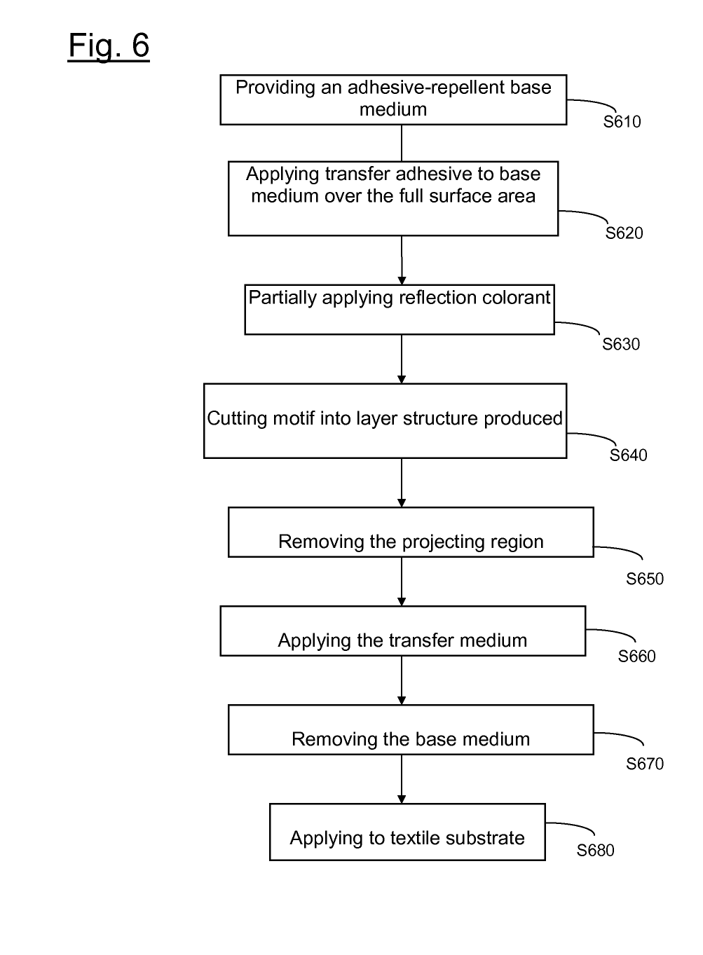

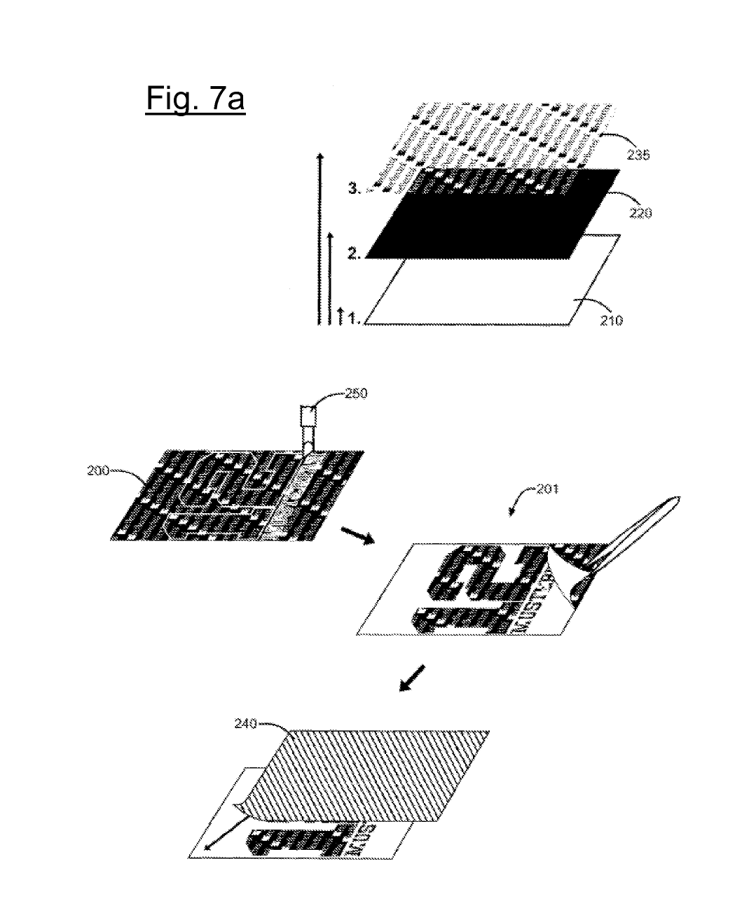

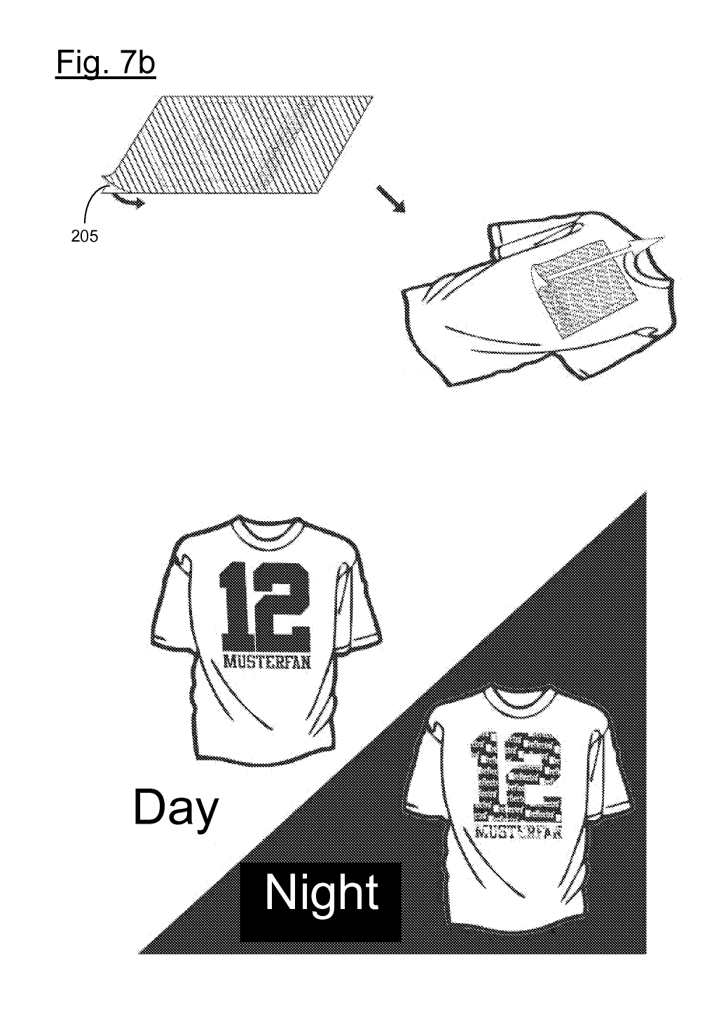

A further embodiment of the method according to the invention is described hereinafter with reference to FIG. 6 and FIG. 7.

The method of FIGS. 6 and 7 differs from that of FIG. 1 in that the reflection colorant is only partially applied in step S630. The structure produced in that partial application of the reflection colorant can represent for example a mark identification as in the example of FIGS. 7a-7b, which appears within the actual motif produced in the layer structure by cutting in the further method similarly to FIG. 1. As a consequence of that partial application of the reflection colorant only the structure in question, which is applied in step S630, reflects upon floodlight illumination (for example at night or at twilight), as shown in FIG. 7b. In that way on the one hand a particularly attractive effect is produced while on the other hand “excessive irradiation” can be prevented, with an excessively strong reflection action which under some circumstances means that the actual motif cannot be perceived or can no longer be exactly perceived.

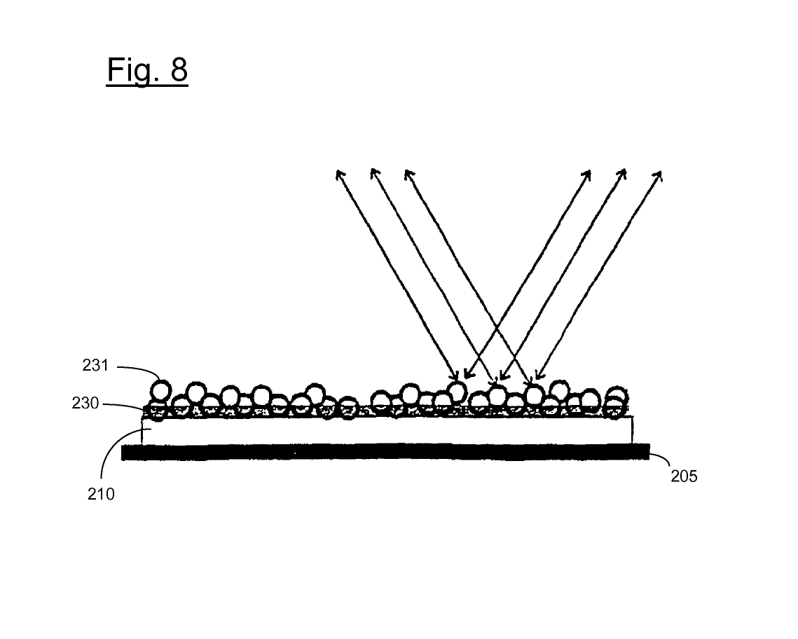

The layer structure produced in the first steps in each of the above-described embodiments is diagrammatically shown in FIG. 8. It includes in this sequence a base medium 205, a transfer adhesive 210, an optional intermediate color layer (not shown) and a reflection colorant 230, wherein that reflection colorant 230 contains a multiplicity of reflection particles 231 (for example of a maximum size of 45 μm), wherein the reflection particles 231 are raised above the surface of the hardened reflection colorant 230. Suitable methods for the production of such reflection transfers are described in EP 1 137 546 B1. In an embodiment the layer structure is of an overall thickness in the range of between 15 μm and 200 μm, in particular in the range of between 25 μm and 100 μm. The small layer thickness provides that the invention is also highly advantageous insofar as for example blade wear in the case of cutting plotters can be markedly reduced and thus the service life of the blades is markedly prolonged, which in turn contributes to a reduction in cost. Consequently it is possible for the first time for even very small motifs to be cut in a reflecting relationship out of a film by means of a simple cutting plotter.

Even if the invention has been described by reference to specific embodiments numerous variations and alternative embodiments will be apparent to the man skilled in the art, for example by combination and/or exchange of features of individual embodiments. Accordingly it will be appreciated by the man skilled in the art that such variations and alternative embodiments are also embraced by the present invention and the scope of the invention is limited only in the sense of the accompanying claims and equivalents thereof.

1. A method of producing a motif having reflecting properties and transferring said motif onto a substrate, wherein the method comprises:
a) providing an adhesive-repellent base medium;
b) applying a transfer adhesive to the base medium over the full surface area;
c) applying a reflection colorant which contains a multiplicity of reflection particle;
d) cutting a motif into the layer structure produced in steps a) through c), wherein a projecting region remains;
e) removing said projecting region; and
f) applying the layer structure having the motif, after removal of the base medium, to a substrate.

2. A method as set forth in claim 1, wherein application of the reflection colorant is effected over the full surface area.

3. A method as set forth in claim 1, wherein application of the reflection colorant is effected partially.

4. A method as set forth in claim 1, wherein application of the layer structure having the motif to the substrate is effected using a transfer tape.

5. A method as set forth in claim 1, wherein cutting of the motif into the layer structure produced in steps a) through c) is effected in correct left-to-right relationship.

6. A method as set forth in claim 4, wherein the transfer tape is applied to the layer structure having the motif after removal of the projecting region.

7. A method as set forth in claim 1, wherein the transfer tape is applied prior to cutting of the motif into the layer structure produced in steps a) through c).

8. A method as set forth in claim 7, wherein steps a)-c) are respectively performed in a roll coating process or a roll printing process.

9. A method as set forth in claim 7, wherein cutting of the motif into the layer structure produced in steps a) through c) is effected after removal of the base medium in mirror-image relationship.

10. A method as set forth in claim 1, wherein after application of the transfer adhesive over the full surface area at least one intermediate layer is applied to the transfer adhesive.

11. A method as set forth in claim 1, wherein in step b) application of the transfer adhesive over the full surface area is effected in an extrusion process or a coating process.

12. A method as set forth in claim 1, wherein after application of the reflection colorant to reflecting regions formed by the reflection colorant non-reflecting elements are applied.

13. A method as set forth in claim 1, wherein the reflection particles are raised above the surface of the hardened reflection colorant.

14. A textile product produced in accordance with a method as set forth in claim 1, wherein the substrate comprises a textile substrate.

15. A reflection transfer film, produced by:
a) providing an adhesive-repellent base medium;
b) applying a transfer adhesive to the base medium over the full surface area;
c) applying a reflection colorant which contains a multiplicity of reflection particles;
d) cutting a motif in correct left-to-right relationship into the layer structure produced in steps a) through c), wherein a projecting region remains; and
e) removing said projecting region.

16. A method as set forth in claim 10, wherein after application of the transfer adhesive over the full surface area, at least one intermediate layer is applied over the full surface area of the transfer adhesive.

17. A method as set forth in claim 12, wherein the non-reflecting elements comprise flock stripes or non-reflecting colorants.
